(19) United States
(12) Patent Application Publication
(10) Pub. No.: US 2005/0213216 A1
(43) Pub. Date: Sep. 29, 2005

(54) Portable lantern and related method of using it

(75) Inventors: Randall L. May, Plano, TX (US); Gary P. Israel, Lantana, TX (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(73) Assignee: The Brinkmann Corporation

(21) Appl. No.: 11/088,080

(22) Filed: Mar. 23, 2005

Related U.S. Application Data
(60) Provisional application No. 60/556,810, filed on Mar. 25, 2004.

(51) Int. Cl. F21H 1/00

(52) U.S. Cl. 359/612

(57) ABSTRACT

A lantern that includes a housing and a reflector assembly having at least one reflector panel that is pivotably coupled to the housing and configured to reflect light produced by the lantern. The housing is configured to interface with a fuel tank and a base. The base is separate from the housing and configured both to interface with the housing when the housing is not interfaced with the fuel tank, and to interface with the fuel tank when the housing also is interfaced with the fuel tank.

### CROSS-REFERENCE TO RELATED APPLICATION

Priority is claimed under 35 U.S.C. § 119(e) to U.S. Provisional Patent Application No. 60/556,810, filed on Mar. 25, 2004, entitled: “PORTABLE LANTERN AND RELATED METHOD OF USING IT,” by Randall L. May, Gary P. Israel, and Robert J. Gross, which application is incorporated by reference herein.

### BACKGROUND OF THE INVENTION

1. Field of the Invention

The invention relates generally to the field of lanterns. More specifically, the invention relates to portable, fuel-burning lanterns.

2. Description of the Related Art

Typically, portable lanterns are used in instances where light is required in a site remote from an electrical connection, e.g., a camp site. Portable lanterns include a fuel storage tank (“fuel tank”) and a fuel delivery system configured within a lantern housing, which defines the outward shape of the portable lantern. The fuel delivery system couples to the fuel tank and includes a burner, at the output of which fuel from the fuel tank is burned to provide light.

The lantern housings of most portable lanterns are of a shape and dimension to receive and house the fuel tank. Thus, current portable lanterns occupy the same space regardless of whether the fuel tank is coupled to the lantern's fuel delivery system. Also, current portable lanterns are configured to emit light radially in all directions from the burner's output, even though the light need be emitted in only one direction. Accordingly, current portable lanterns inefficiently direct light in all radial directions.

It should, therefore, be appreciated that there is a need for a portable lantern that provides for more efficient use of space when the fuel tank is not coupled to the fuel delivery system. Also, it should be appreciated that there is a need for a portable lantern that more efficiently directs the light emitted from the portable lantern. The present invention satisfies these needs.

### SUMMARY OF THE INVENTION

The present invention resides in a portable lantern and related method of use that provide for more efficient use of space when a fuel tank is not coupled to the lantern's fuel delivery system, and more efficiently directs the light emitted from the portable lantern. More particularly, the invention resides in embodiments of a reflector assembly that is configured for use with a lantern. The reflector assembly includes at least one reflector panel that is pivotably coupled to the lantern and configured to reflect light produced by the lantern.

In other, more detailed features of the invention, the reflector assembly further includes a slide that interfaces with the at least one reflector panel, and couples to the lantern. When a user moves the slide from a first position to a second position the at least one reflector panel pivots relative to the lantern. Also, the slide can have an arcuate shape. In addition, the slide can include fingers that interface with the at least one reflector panel.

The reflector assembly can further include a tab that is coupled to the slide and configured to facilitate the movement of the slide by the user from the first position to the second position. Also, the reflector assembly can further include a post coupled between the tab and the slide. In addition, the reflector assembly can further include a wire that is coupled to the lantern. The post slides against the wire when the user pushes against the tab causing the slide to move from the first position to the second position. Furthermore, the wire can be bent so as to include at least one recessed region that is configured to interface with the post.

The at least one reflector assembly can include a plurality of reflector panels, and the reflector assembly can have a closed position in which adjacent reflector panels included in the plurality of reflector panels overlap one another. Also, when the reflector panel is in its closed position, the plurality of reflector panels blocks the path of light through the reflector assembly and reflects the light. In addition, the reflector assembly can have at least one open position in which adjacent reflector panels are pivoted relative to the lantern so that at least a portion of the light passes through the reflector assembly.

The present invention also resides in a lantern that includes a housing configured to interface with a fuel tank, and a reflector assembly that is coupled to the housing and includes at least one reflector panel. The at least one reflector panel is pivotably coupled to the housing and configured to reflect light produced by the lantern.

Also, the housing can include a housing bottom and a fuel delivery and ignition system. The fuel delivery and ignition system is coupled to the housing bottom and includes at least one burner. The fuel delivery and ignition system is configured to couple to the fuel tank and to regulate the rate of flow of fuel that is output from the fuel tank, that passes through the at least one burner, and that leaves the at least one burner.

In addition, the fuel delivery and ignition system can further include a knob that is rotatably coupled to the housing bottom. The rotational position of the knob relative to the housing bottom determines the rate of flow of the fuel output from the fuel tank through the at least one burner. Also, the fuel delivery and ignition system can include a pressable igniter button, and an ignition electrode. The pressable igniter button is coupled to the housing bottom. The ignition electrode is coupled to the housing bottom and configured to emit an electrical spark after a user presses the igniter button. The electrical spark is used to ignite the fuel that leaves the at least one burner.

The housing can further include a shield assembly coupled to the housing bottom that encompasses the at least one burner. Also, the shield assembly can be rotatably coupled to the housing bottom. In addition, the shield assembly can include at least one ring that interfaces with the housing bottom, and the at least one reflector panel is pivotably coupled to the at least one ring.

The reflector assembly can further include a slide that interfaces with the at least one reflector panel. The slide is slidably coupled to the at least one ring. When a user moves the slide from a first position to a second position, the at least one reflector panel pivots relative to the at least one ring. Also, the reflector assembly can further includes a tab that is coupled to the slide and configured to facilitate the movement of the slide by the user from the first position to the second position.

Also, the at least one reflector panel can include a plurality of reflector panels, and the reflector assembly has a closed position in which adjacent reflector panels included in the plurality of reflector panels overlap one another. The plurality of reflector panels can block the path of the light through the reflector assembly and reflect the light when the reflector assembly is in its closed position. Furthermore, the reflector assembly also can have at least one open position in which adjacent reflector panels are pivoted relative to the housing so at least a portion of the light passes through the reflector assembly.

In other, more detailed features of the invention, the housing has a cross-sectional shape that is generally cylindrical. Also, the lantern can further include a base that is separate from the housing and configured both to interface with the housing when the housing is not interfaced with the fuel tank, and to interface with the fuel tank when the housing also is interfaced with the fuel tank. Also, the lantern has a height, and the height of the lantern when the housing interfaces directly with the base is less than the height of the lantern when the fuel tank is interfaced between the housing and the base.

In addition, the base can include at least one foot that is configured to stabilize a position of the lantern. Furthermore, the base can include a collar that is configured to interface with the housing or the fuel tank. Also, the collar can include a surface having ridges that contact the housing or the fuel tank when the housing or the fuel tank are interfaced with the base. In addition, the collar can include a notch configured to facilitate the interfacing of the housing with the base.

The present invention also resides in a method for reflecting light that is generated by a lantern. The method includes providing the lantern; providing a reflector assembly that is coupled to the lantern and that includes at least one reflector panel, the at least one reflector panel is pivotably coupled to the lantern and configured to reflect light; and pivoting the at least one reflector panel relative to the lantern resulting in at least a portion of the light being reflected by the at least one reflector panel.

The method can further include providing a slide that interfaces with the at least one reflector panel, and that is slidably coupled to the lantern; and sliding the slide from a first position to a second position causing the at least one reflector panel to pivot relative to the lantern. Also, the method can further include providing a tab that is coupled to the slide, and pushing the tab to slide the slide from the first position to the second position. In addition, the method can further include providing a post that is coupled between the tab and the slide, and providing a wire coupled to the lantern that contacts the post, wherein pushing the tab causes the post to slide against the wire.

Other features of the invention should become apparent to those skilled in the art from the following description of the preferred embodiments taken in conjunction with the accompanying drawings, which illustrate, by way of example, the principles of the invention, the invention not being limited to any particular preferred embodiment(s) disclosed.

### BRIEF DESCRIPTION OF THE DRAWINGS

FIG. 1 is a perspective view of a portable lantern according to a preferred embodiment with a reflector assembly in the closed position.

FIG. 2 is a front elevational view of the portable lantern of FIG. 1.

FIG. 3 is a side elevational view of the portable lantern of FIG. 1.

FIG. 4 is an exploded perspective view of a portion of a shield assembly and its reflector assembly.

FIG. 5 is a rear elevational view of the portable lantern of FIG. 1.

FIG. 6 is a sectional view of the shield assembly with the reflector assembly in its closed position taken along the line 6-6 in FIG. 2.

FIG. 7 is a rear elevational view of the portable lantern of FIG. 1 with the reflector assembly in its fully open position.

FIG. 8 is a sectional view of the shield assembly with the reflector assembly in its fully open position taken along the line 8-8 in FIG. 7.

FIG. 9 is a partial sectional view of the shield assembly with the reflector assembly in its closed position taken along the line 9-9 in FIG. 5.

FIG. 10 is a partial sectional view of the shield assembly with the reflector assembly in its fully open position taken along the line 10-10 in FIG. 7.

FIG. 11 is a perspective view of a base of the portable lantern of FIG. 1.

FIG. 12 is a top plan view of the base of FIG. 11.

FIG. 13 is a front elevational view of the portable lantern of FIG. 1 without a fuel tank.

### DETAILED DESCRIPTION OF THE PREFERRED EMBODIMENTS

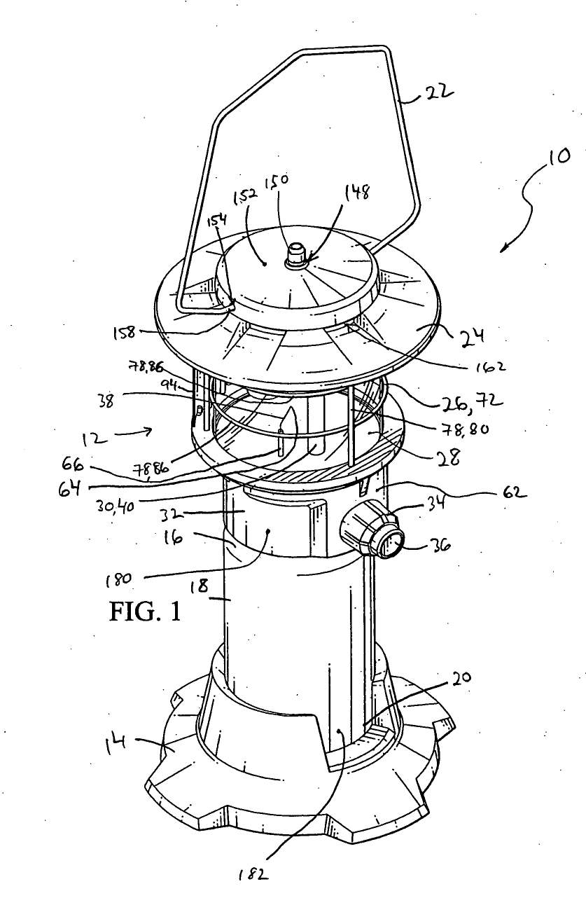

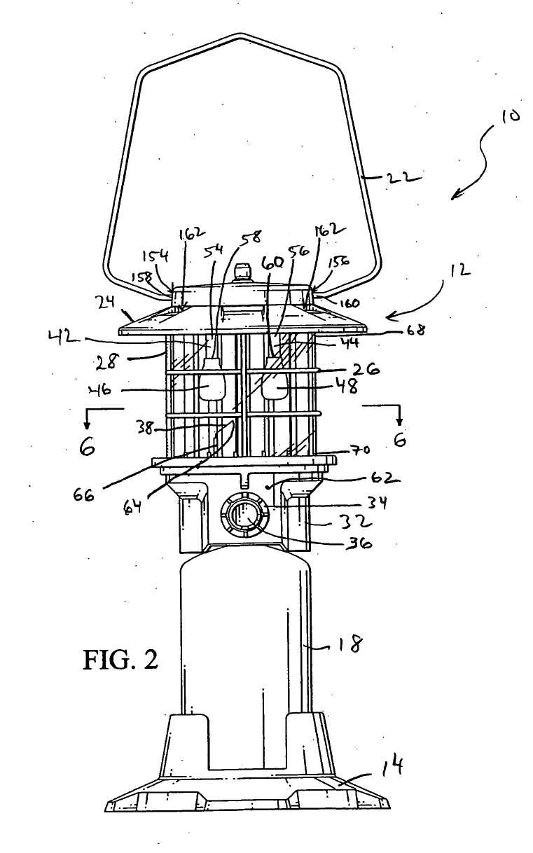

With reference now to the illustrative drawings, and particularly to FIGS. 1 and 2, there is shown a portable lantern 10, which includes a housing 12 and a base 14. One end 16 of a fuel tank 18 can be coupled to the housing, and an opposite end 20 of the fuel tank can be coupled to the base, as discussed below. The fuel tank can contain any of various types of fuel, e.g., liquid propane or butane. The housing includes a lantern handle 22, a housing top 24, a shield assembly 26, a globe 28, a fuel delivery and ignition system 30, and a housing bottom 32.

As shown in FIGS. 1-3, the housing 12 is generally cylindrical in shape, as defined by the housing top 24, shield assembly 26, globe 28, and housing bottom 32. However, it should be understood that the general shape of the housing can be other than cylindrical, e.g., the general shape of the housing can be such that a cross section of the housing is generally square or elliptical in shape.

The fuel delivery and ignition system 30 is coupled to the housing bottom 32, and includes a regulator (not shown), a knob 34, an igniter button 36, an ignition electrode 38, a tube 40, a circular manifold (not shown), two burners 42 and 44, and two mantles 46 and 48, respectively. The housing bottom can be made from a variety of materials, e.g., dicast aluminum. When the housing 12 is coupled to the fuel tank 18, the regulator's input (not shown) interfaces with an output nozzle (not shown) of the fuel tank. In preferred embodiments, the regulator screws onto the fuel tank's threaded output nozzle. When the regulator is coupled to the fuel tank's output nozzle, fuel, in gas form, leaves the fuel tank, passes through the regulator's output (not shown), and flows into one end 50 of the tube, which is coupled to the housing bottom. The opposite end 52 of the tube is coupled to the manifold, which is also coupled to one end 54 and 56 of each of the two burners 42 and 44, respectively. The opposite end 58 and 60 of each of the two burners 42 and 44, respectively, includes a recessed groove (not shown) to which a mantle 46 and 48, respectively, can be coupled by tying the mantle around the recessed grove using thread (not shown). The tube and manifold can be fabricated from many different materials, e.g., steel or stainless steel. The two burners can be fabricated from many different materials, e.g., brass. The manifold is coupled to tube and the burners by known means, e.g., soldering or welding. Each of the mantles is made of a flame-resistance fabric, e.g., a cloth material impregnated with light-emitting chemicals.

A threaded bolt (not shown) is coupled at one end (not shown) to the top surface (not shown) of the manifold (not shown). The other end (not shown) of the bolt extends perpendicularly away from the top surface of the manifold, and is used to secure the housing top 24 to the rest of the portable lantern 10, as discussed below. A post (not shown), which is used during the lantern's lighting process, as discussed below, is connected to the tube 40 between its opposite ends 50 and 52 and near the ignition electrode 38. The post can be made from many different materials, e.g., steel or stainless steel, and can be attached to the tube by known means, e.g., soldering or welding.

The knob 34 is rotatably mounted to a front portion 62 of the housing bottom 32 and is coupled to the regulator (not shown). The knob is cylindrical in shape and can be made from various materials, e.g., plastic. When the knob is rotated fully clockwise, i.e., the knob can not be rotated further in the clockwise direction as viewed from the front of the portable lantern 10, the regulator is in its closed position, and no fuel passes through the regulator. As the knob is rotated counter-clockwise from the fully clockwise position, fuel, in gas form, is allowed to pass through the regulator and into the tube 40. As the knob is rotated further in the counter-clockwise direction, the flow rate of the fuel through the regulator is increased. Finally, when the knob can no longer be rotated further in the counter-clockwise direction, the regulator is in its fully open position, thus, allowing for the maximum flow rate of fuel into the tube from the regulator. When the regulator is in an open position, as determined by the rotational position of the knob, fuel leaves the fuel tank, and flows through the regulator, tube, manifold (not shown), and burners 42 and 44, and flows into the mantles 46 and 48.

Coaxially positioned within the knob 34 is the igniter button 36, which operates independently from the knob. The igniter button can be made from the same materials as the knob. During use, after the knob has been rotated to a position that opens the regulator (not shown), and an initial quantity of fuel has filled the mantles 46 and 48, a user can press the igniter button inward. Initially, as the igniter button is pressed inward, the igniter button cocks a spring-loaded hammer (not shown) included in a piezo-electric igniter (not shown) internal to the housing bottom 32. Eventually, after the igniter button moves the spring-loaded hammer beyond its trigger point, the spring-loaded hammer will fall against a piezo-electric element (not shown) included in the piezo-electric igniter. The impact of the spring-loaded hammer with the piezo-electric element will result in an audible click that is heard by the user, and the generation of an electrical spark (not shown) from one end 64 of the ignition electrode 38 to the post (not shown) that extends from the tube 40 near the ignition electrode. The ignition electrode can be made from various materials, e.g., stainless steel. The other end 66 of the ignition electrode is surrounded by an electrical insulating material, e.g., a ceramic insulator, and is coupled to the housing bottom. The electrical spark created between the ignition electrode and the post has a large electrical potential, e.g., between 15,000 volts and 18,000 volts, which causes the fuel in and around the mantles to ignite, thus, lighting the portable lantern 10.

The shield assembly 26 surrounds the globe 28, and the combination of the shield assembly and the globe are positioned between the housing top 24 and the housing bottom 32. In preferred embodiments, the globe is a cylinder that is open at its upper and lower ends 68 and 70, respectively. The globe is transparent and can be made from various materials, e.g., high-temperature glass or a metal screen. Also, it should be understood that the globe could be made from colored materials, e.g., colored glass, or include colored patterns. In addition, in instances where the globe is made of glass, portions of the globe may include patterns that have been sandblasted or etched into the globe's surface. In preferred embodiments, the globe is made from clear glass.

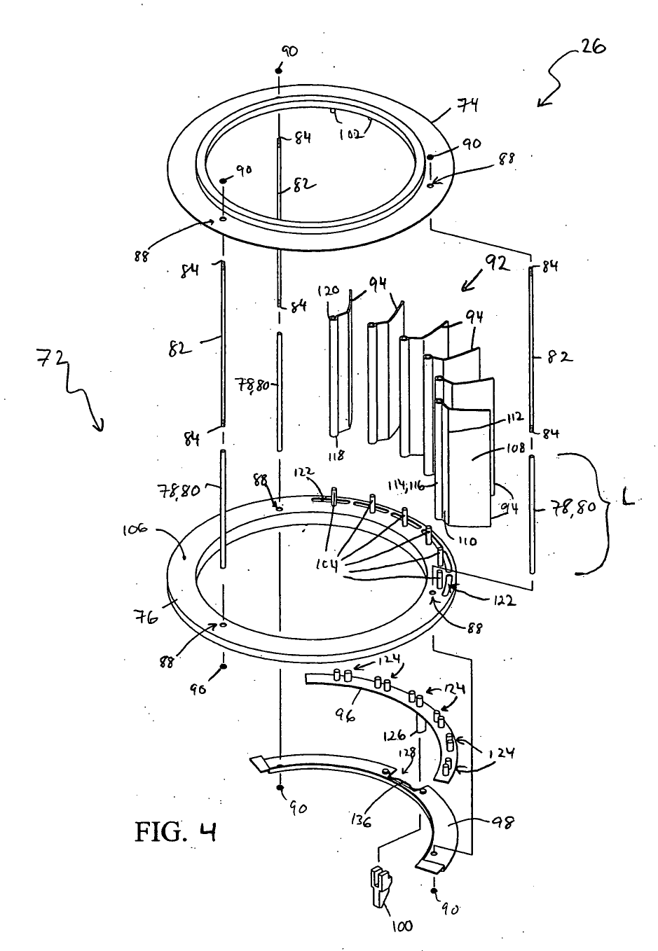

Referring additionally to the exploded view of FIG. 4, in preferred embodiments, the shield assembly 26 includes a cylindrical cage 72 formed from a top ring 74 and a bottom ring 76 and pieces of tubing 78 coupled between the top and bottom rings. The shield assembly surrounds the globe 28 and is designed to protect the globe from scratching and breaking due to impacts with external objects (not shown). Preferably, the pieces of tubing are formed from a metal, e.g., chrome-plated steel or stainless steel, and the top and bottom rings are formed from a metal, e.g., steel or stainless steel.

As illustrated in FIG. 4, the top and bottom rings 74 and 76, respectively, are coupled to one another, and held in a fixed relation to one another, using three straight tubes 80 through which cylindrical rods 82, each having threaded ends 84, are inserted. Referring again to FIGS. 1 and 2, two circular tubes 86 are connected, e.g., by welding or soldering, to the three straight tubes, in such a way as to hold the three straight tubes in a generally parallel relationship to one another. After a cylindrical rod is inserted through each straight tube, and each threaded end is inserted through one of three holes 88 in the top or bottom ring, a nut 90 is rotatably fastened to the threaded end. This results in the top and bottom rings being held in a relatively parallel and fixed relation to one another, and spaced apart by the length “L” of the straight tubes. In additional embodiments, material having a solid cross section instead of a hollow cross section can be used to form the cylindrical cage 72 of the shield assembly 26. For example, the cylindrical cage can be formed from thick metal wire.

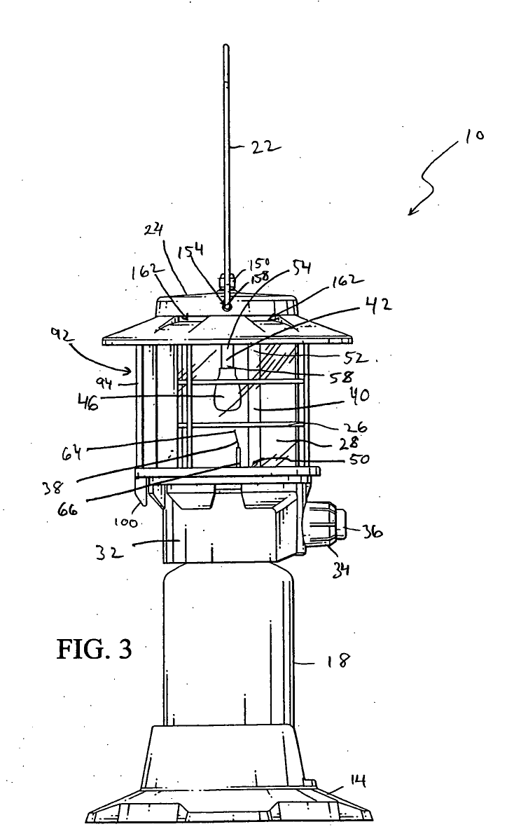

As illustrated in FIGS. 3-6, the shield assembly 26 also includes a reflector assembly 92 made up of six reflector panels 94, an arcuate slide 96, a mounting panel 98, and a tab 100. The six reflector panels, arcuate slide, mounting panel, and tab can be made from a variety of materials. For example, the six reflector panels, arcuate slide, and mounting panel can be made from polished aluminum or stainless steel, and the tab can be made from a high-temperature plastic, e.g., glass-filled nylon. While the reflector assembly discussed herein, and illustrated in the drawings, includes only six reflector panels, it should be understood that the reflector assembly can include any number of reflector panels.

As illustrated in FIG. 4, the shield assembly's top and bottom rings 74 and 76, respectively, each include six posts 102 and 104, respectively, that perpendicularly extend from each ring. More specifically, the posts 102 extend perpendicularly downward from the bottom surface (not shown) of the top ring 74, and the posts 104 extend perpendicularly upward from the top surface 106 of the bottom ring 76. Also, the top and bottom rings are positioned such that each of the top ring's posts 102 is aligned approximately with one of the bottom ring's posts 104.

Each reflector panel 94 includes a main panel 108, which is relatively flat and rectangular in shape, and a dogleg portion 110 that extends at an angle from one edge 112 of the main panel. The end 114 of the dogleg portion that does not connect to the main panel is formed into a hollow cylindrical tube 116.

During fabrication of the shield assembly 26, one end 118 of each reflector panel's cylindrical tube 116 is slipped over one of the bottom ring's posts 104 and the opposite end 120 of the reflector panel's cylindrical tube is slipped over the aligned top ring's post 102. This configuration is the same for each of the reflector panels 94. Accordingly, due to the interface between each reflector panel's cylindrical tube and the posts in both the top and bottom ring, each reflector panel is rotatably coupled to the top and bottom rings 74 and 76, respectively, of the shield assembly.

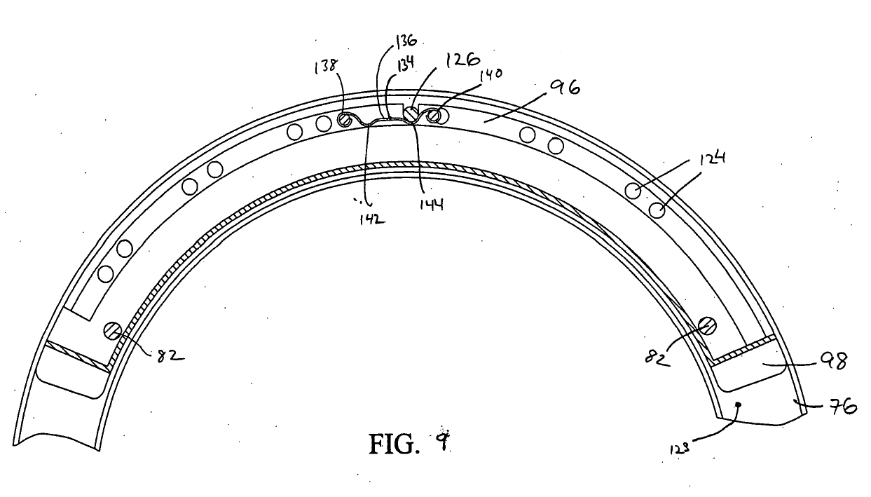

The bottom ring 76 additionally includes six slots 122, with each of the slots positioned adjacent to one of the bottom ring's posts 104. Referring additionally to FIG. 9, the arcuate slide 96 is positioned between the bottom ring and the mounting panel 98, which is coupled to the bottom surface 123 of the bottom ring. The arcuate slide is configured to slide back and forth below the six slots in the bottom ring. The arcuate slide includes six pairs of fingers 124, where each pair of fingers extends upward through one of the six slots in the bottom ring. The end 118 of each reflector panel 94 adjacent to the bottom ring is positioned between one of the pairs of fingers. The arcuate slide also includes a post 126 that extends downward through a notch 128 in the mounting panel. The tab 100 is coupled to the post, and is the interface through which a user moves the arcuate slide.

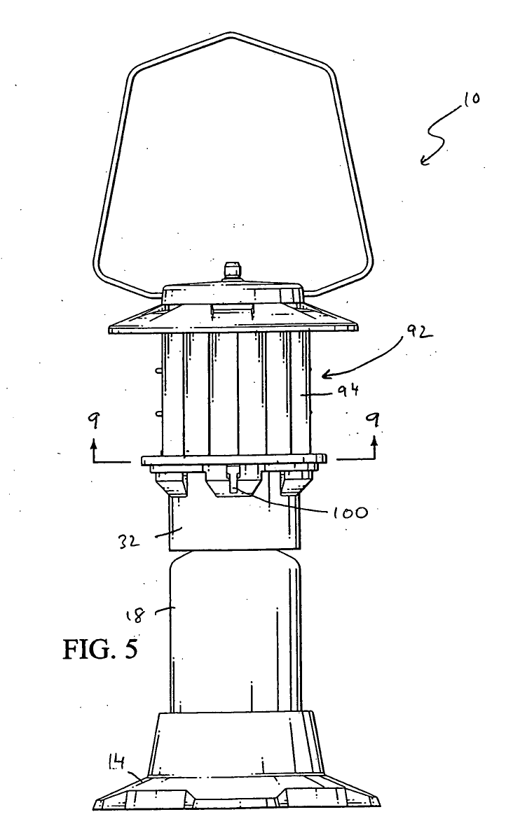

As illustrated in FIG. 5, the reflector assembly 92 substantially surrounds the rear of the portable lantern's globe 28. Throughout this discussion of the portable lantern 10, the rear of the portable lantern is the side of the portable lantern that includes the reflector assembly. However, it is to be understood that the shield assembly 26, and, thus the reflector assembly, can be rotated about the globe and the components internal to the globe, e.g., the tube 40, the manifold (not shown), the burners 42 and 44, and the mantles 46 and 48. Therefore, the reflector assembly can be rotated from the rear of the portable lantern around to the front of the portable lantern and to points in between.

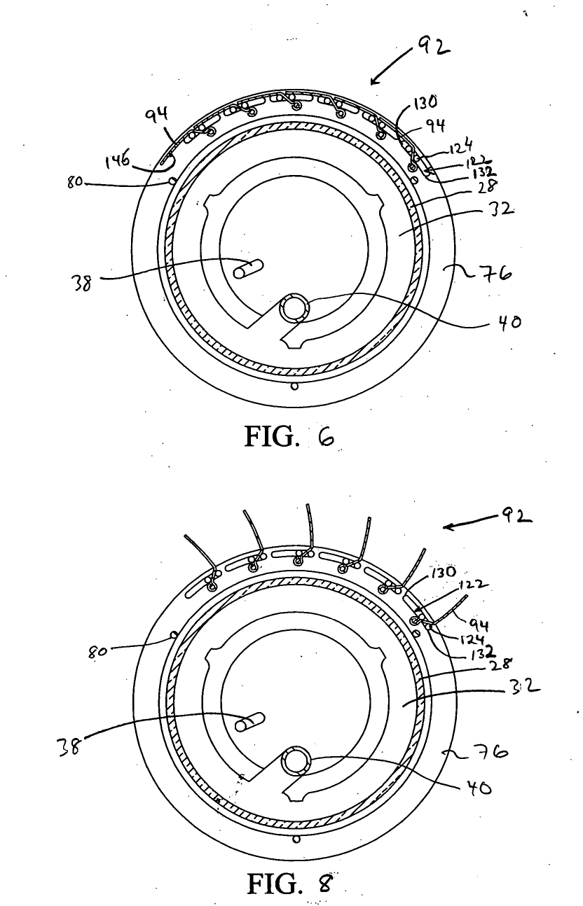

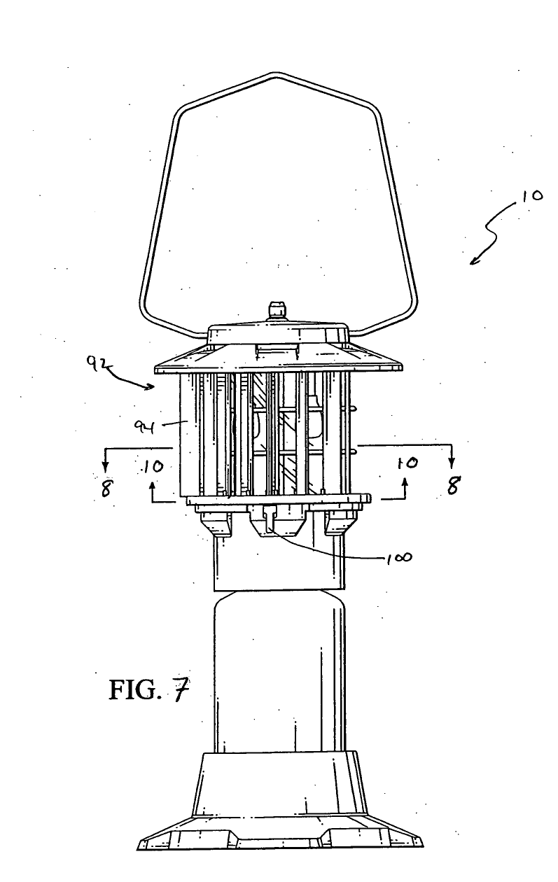

As illustrated in FIGS. 5 and 6, and referring additionally to FIG. 2, when viewing the portable lantern 10 from behind, a user can push the tab 100 fully to the right, which pushes the arcuate slide 96 fully to the right, moves each of the pair of fingers 124 to the right-hand end 130 of each slot 122, and, in turn, pivots each of the reflector panels 94 toward the globe 28, resulting in the reflector assembly 92 assuming its closed position. Referring additionally to FIGS. 7 and 8, the user can push the tab fully to the left, which in turn, pushes the arcuate slide to the left, moves each of the pair of fingers to the left-hand end 132 of each slot, and, in turn, pivots each of the reflector panels away from the globe, resulting in the reflector assembly assuming its fully open position. Furthermore, the arcuate slide can be moved so that the reflector assembly is positioned in an open position between the closed position and the fully open position.

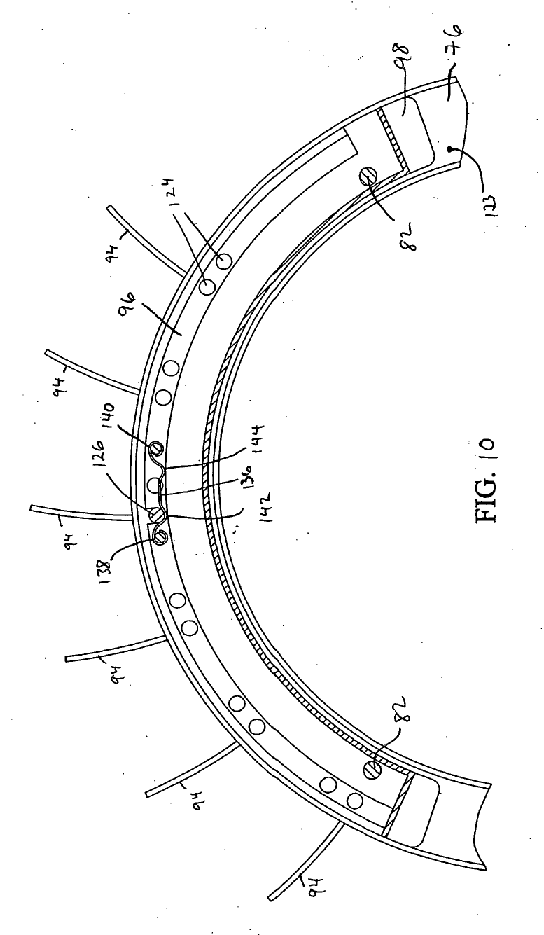

Referring to FIGS. 4, 9, and 10, the arcuate slide's post 126 contacts the surface 134 of a bent wire 136 having opposite ends 138 and 140 that are coupled to the mounting panel 98 adjacent to the mounting panel's notch 128. As the tab 100 is moved, the post slides from one -position to another along the bent wire. The wire is bent so as to include two recessed regions 142 and 144 located adjacent to opposite ends 138 and 140, respectively, of the mounting panel's notch. When the post is in one of its extreme far left or right positions, i.e., the post positions where the reflector assembly 92 is in its fully open position or closed position, respectively, the post contacts one of the two recessed regions of the wire, as illustrated in FIGS. 10 and 9, respectively.

Referring to FIGS. 5 and 6, when the reflector assembly 92 is in its closed position, adjacent reflector panels 94 overlap with one another forming an optical barrier to the path of light through the reflector assembly, and, thus the path of light through the rear of the portable lantern 10. Also, since the reflector panels are made of a reflective metal, e.g., polished aluminum, or includes a reflective coating (not shown) on the surface 146 of the reflector panel that faces the mantles 46 and 48 when the reflector assembly is in its closed position, the reflector assembly redirects light, initially cast out from the mantles toward the reflector assembly, toward the front of the portable lantern. Thus, when the reflector assembly is in its closed position, the portable lantern provides more light through the front of the portable lantern than when the reflector assembly is in its fully open position.

Referring again to FIG. 1, the housing top 24, which can be made from a variety of materials, e.g., porcelain-coated steel, includes a central hole 148 through which one end (not shown) of the bolt (not shown) that is connected to the manifold (not shown) extends when the housing top is coupled to the rest of the housing 12. The housing top is secured to the bolt with a nut 150 that both couples to the bolt and presses against the outside surface 152 of the housing top, thus, forcing the housing top in contact with the top ring 74 of the shield assembly 26. Referring additionally to FIGS. 2 and 3, the housing top also includes two side holes 154 and 156 into which the ends 158 and 160, respectively, of the lantern handle 22 insert, allowing for the lantern handle to pivot relative to the rest of the portable lantern 10. The lantern handle can be made from a variety of materials, e.g., chrome-plated steel wire, of suitable stiffness to carry the portable lantern's weight. The housing top also includes six vents 162 through which the air heated by the burning fuel and other exhaust gases within the globe 28 can escape from the portable lantern and into the surrounding environment.

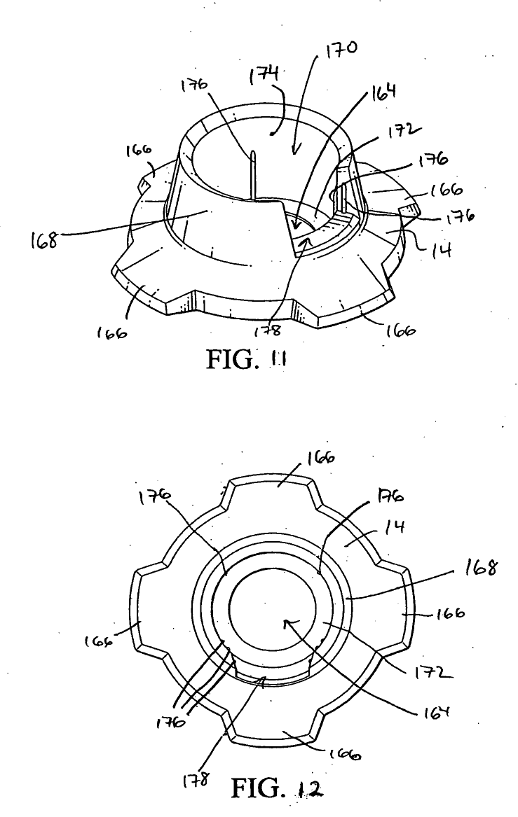

Referring to FIGS. 11 and 12, when viewed from above, the lantern base 14 is circular in shape with a hole 164 in the center. The lantern base includes four feet 166, which assist in maintaining a stable vertical position of the portable lantern 10, and, thus aid in preventing the portable lantern from tipping over. Included as part of the base, and extending upward, is a cylindrical collar 168, which defines a recess 170. The bottom of the recess is defined by a base ring 172 that surrounds the base's hole. The base can be fabricated from various materials, e.g., plastic.

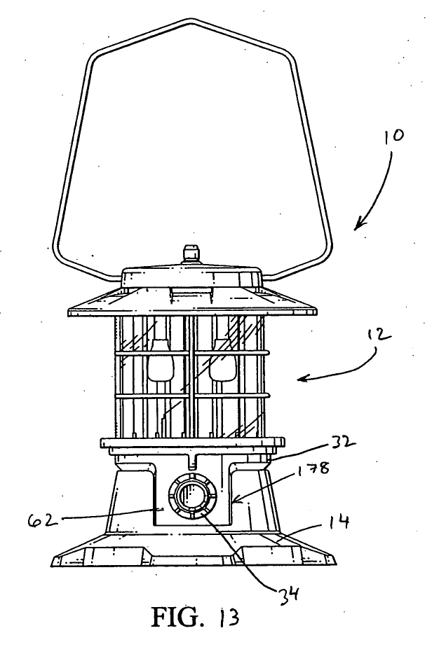

The inside surface 174 of the collar 168 includes ridges 176 that extend from the inside surface of the collar to the base ring 172. The portable lantern's housing 12 is configured to insert into the recess 170 and interface with the base 14 when a fuel tank 18 is not coupled to the housing, as illustrated in FIG. 13. As such, the collar also includes a base notch 178 for the receipt of the front portion 62 of the housing bottom 32, including the knob 34, when the portable lantern's housing interfaces with the base.

Also, referring to FIG. 1, when one end 16 of a fuel tank 18 is coupled to the portable lantern's housing 12, the base 14 is configured to receive the opposite end 20 of the fuel tank in the recess 170. The movement of a fuel tank into the base is limited by the base ring 172 at the bottom of the recess. When the portable lantern's housing or the fuel tank is inserted into the base's recess, the housing or the tank is secured in place by the contact between the ridges 176 and an outside surface 180 or 182 of the housing or fuel tank, respectively.

Advantageously, the portable lantern's housing 12 and base 14 can interface with one another when a fuel tank 18 is not coupled to the housing. This facilitates ease in storage and co-location of the portable lantern's components. Also, the portable lantern 10 advantageously is designed to incorporate the fuel tank as part of the structure of the lantern, thus, preventing the need for additional structure to receive the fuel tank and to connect the base to the housing.

Also, advantageously, the lantern's reflector assembly 92 can be moved from its closed position to one of many open positions. The range of variability allows for a varying amount of light to pass through the reflector assembly, and a varying amount of light to be reflected by the reflector assembly out through the front of the portable lantern 10. With the reflector assembly in its closed position, the portable lantern advantageously provides a larger amount of light through the front of the portable lantern, than would be the case if the reflector assembly were in an open position. It is presumed that the user will face the front of the portable lantern toward an object (not shown) to be illuminated. Often, the user does not view objects illuminated by light output through the rear of the lantern, the side of the lantern covered by the reflector assembly. Accordingly, the portable lantern advantageously provides a larger amount of light to illuminate objects of interest.

The foregoing detailed description of the present invention is provided for purposes of illustration, and it is not intended to be exhaustive or to limit the invention to the particular embodiments disclosed. The embodiments can provide different capabilities and benefits, depending on the configuration used to implement the key features of the invention. Accordingly, the scope of the invention is defined only by the following claims.

1. A reflector assembly that is configured for use with a lantern, the reflector assembly comprising at least one reflector panel that is pivotably coupled to the lantern and configured to reflect light produced by the lantern.

2. The reflector assembly according to claim 1, further comprising a slide that interfaces with the at least one reflector panel, and couples to the lantern, wherein when a user moves the slide from a first position to a second position the at least one reflector panel pivots relative to the lantern.

3. The reflector assembly according to claim 2, wherein the slide has an arcuate shape.

4. The reflector assembly according to claim 2, wherein the slide includes fingers that interface with the at least one reflector panel.

5. The reflector assembly according to claim 2, further comprising a tab coupled to the slide and configured to facilitate the movement of the slide by the user from the first position to the second position.

6. The reflector assembly according to claim 5, further comprising a post coupled between the tab and the slide.

7. The reflector assembly according to claim 6, further comprising a wire coupled to the lantern and against which the post slides when the user pushes against the tab causing the slide to move from the first position to the second position.

8. The reflector assembly according to claim 7, wherein the wire is bent forming at least one recessed region that is configured to interface with the post.

9. The reflector assembly according to claim 1, wherein the at least one reflector panel includes a plurality of reflector panels, and the reflector assembly has a closed position in which adjacent reflector panels included in the plurality of reflector panels overlap one another.

10. The reflector assembly according to claim 9, wherein when the reflector panel is in its closed position, the plurality of reflector panels blocks the path of the light through the reflector assembly and reflects the light.

11. The reflector assembly according to claim 9, wherein the reflector assembly has at least one open position in which adjacent reflector panels are pivoted relative to the lantern so that at least a portion of the light passes through the reflector assembly.

12. A lantern comprising:
a. a housing configured to interface with a fuel tank; and
b. a reflector assembly coupled to the housing and including at least one reflector panel that is pivotably coupled to the housing and configured to reflect light produced by the lantern.

13. The lantern according to claim 12, wherein the housing includes:
a. a housing bottom; and
b. a fuel delivery and ignition system coupled to the housing bottom that includes at least one burner, the fuel delivery and ignition system is configured to couple to the fuel tank and to regulate the rate of flow of fuel that is output from the fuel tank, that passes through the at least one burner, and that leaves the at least one burner.

14. The lantern according to claim 13, wherein the fuel delivery and ignition system further includes a knob that is rotatably coupled to the housing bottom, wherein the rotational position of the knob relative to the housing bottom determines the rate of flow of the fuel output from the fuel tank through the at least one burner.

15. The lantern according to claim 13, wherein the fuel delivery and ignition system includes:
a. a pressable igniter button coupled to the housing bottom; and
b. an ignition electrode coupled to the housing bottom and configured to emit an electrical spark after a user presses the igniter button;
c. wherein the electrical spark is used to ignite the fuel that leaves the at least one burner.

16. The lantern according to claim 13, wherein the housing further includes a shield assembly coupled to the housing bottom that encompasses the at least one burner.

17. The lantern according to claim 16, wherein the shield assembly is rotatably coupled to the housing bottom.

18. The lantern according to claim 16, wherein the shield assembly includes at least one ring that interfaces with the housing bottom, and the at least one reflector panel is pivotably coupled to the at least one ring.

19. The lantern according to claim 18, wherein the reflector assembly further includes a slide that interfaces with the at least one reflector panel, and is slidably coupled to the at least one ring, wherein, when a user moves the slide from a first position to a second position, the at least one reflector panel pivots relative to the at least one ring.

20. The lantern according to claim 19, further comprising a tab that is coupled to the slide and configured to facilitate the movement of the slide by the user from the first position to the second position.

21. The lantern according to claim 12, wherein:
a. the at least one reflector panel includes a plurality of reflector panels;
b. the reflector assembly has a closed position in which adjacent reflector panels included in the plurality of reflector panels overlap one another; and
c. the plurality of reflector panels blocks the path of the light through the reflector assembly and reflects the light when the reflector assembly is in its closed position.

22. The lantern according to claim 21, wherein the reflector assembly also has at least one open position in which adjacent reflector panels are pivoted relative to the housing so at least a portion of the light passes through the reflector assembly.

23. The lantern according to claim 12, wherein the housing has a shape that is generally cylindrical.

24. The lantern according to claim 12, further comprising a base that is separate from the housing and configured both to interface with the housing when the housing is not interfaced with the fuel tank, and to interface with the fuel tank when the housing also is interfaced with the fuel tank.

25. The lantern according to claim 24, wherein the lantern has a height, and the height of the lantern when the housing interfaces directly with the base is less than the height of the lantern when the fuel tank is interfaced between the housing and the base.

26. The lantern according to claim 24, wherein base includes at least one foot that is configured to stabilize a position of the lantern.

27. The lantern according to claim 24, wherein the base includes a collar that is configured to interface with the housing or the fuel tank.

28. The lantern according to claim 27, wherein the collar includes a surface having ridges that contact the housing or the fuel tank when the housing or the fuel tank are interfaced with the base.

29. The lantern according to claim 27, wherein the collar includes a notch configured to facilitate the interfacing of the housing with the base.

30. A method for reflecting light generated by a lantern, the method comprising:
a. providing the lantern;
b. providing a reflector assembly coupled to the lantern that includes at least one reflector panel, wherein the at least one reflector panel is pivotably coupled to the lantern and configured to reflect light; and
c. pivoting the at least one reflector panel relative to the lantern resulting in at least a portion of the light being reflected by the at least one reflector panel.

31. The method according to claim 30, further comprising:
a. providing a slide that interfaces with the at least one reflector panel, and is slidably coupled to the lantern; and
b. sliding the slide from a first position to a second position causing the at least one reflector panel to pivot relative to the lantern.

32. The method according to claim 31, further comprising:
a. providing a tab coupled to the slide; and
b. pushing the tab to slide the slide from the first position to the second position.

33. The method according to claim 32, further comprising:
a. providing a post coupled between the tab and the slide; and
b. providing a wire coupled to the lantern that contacts the post;
c. wherein pushing the tab causes the post to slide against the wire.
